(19) United States
(12) Patent Application Publication
(10) Pub. No.: US 2003/0233751 A1
(43) Pub. Date: Dec. 25, 2003

(54) Syphon support flange

(76) Inventor: Mark W. Franks, Winter Haven, FL (US)

Correspondence Address: Killworth, Gottman, Hagan & Schaeff, LLP, One Dayton Centre, One South Main Street, Suite 500, Dayton, OH, 45402, US

(21) Appl. No.: 10/401,925

(22) Filed: Mar. 28, 2003

Related U.S. Application Data
(60) Provisional application No. 60/370,479, filed on Apr. 5, 2002.

(51) Int. Cl. B23P 11/00

(52) U.S. Cl. 29/898.07; 29/525.01

(57) ABSTRACT

Rotating vessels that are heated or cooled, often utilize stationary syphons, which provide an outlet passage for the liquid/gas media. The syphon may be supported by adding a syphon support flange to the existing stationary syphon system to provide additional support for the syphon, which helps to add service life time to the syphon and the rotary joint.

### CROSS REFERENCE TO RELATED APPLICATIONS

This present application is related to U.S. provisional patent application Ser. No. 06/370,479, filed on Apr. 5, 2002, entitled “Syphon Support Flange,” and the benefit of the earlier Apr. 5, 2002 filing date is claimed for the present application in accordance with 35 U.S.C. § 119 (e)(1).

### FIELD OF THE INVENTION

The invention pertains to syphon systems and more particularly to support techniques in syphon systems.

### BACKGROUND

Rotating vessels, dryers, or cylinders are utilized to heat or cool a moving web of material. These vessels are often used in the manufacture of paper, corrugated containers, rubbers, plastics, steel, textiles, and the like. The vessels are typically horizontal cylinders, supported at both ends by journals mounted on bearings and have at least one hollow journal, through which heating media, such as steam or condensate, or cooling media, such as cold water or compressed air, is passed.

When rotating vessels were first used for this purpose, the heating or cooling media flowed into the journal, filled the cylinder to a half full state, and flowed back out the same journal. This flow added a tremendous amount of liquid weight to the vessel, thereby stressing and causing the drive components that make the vessel rotate and the bearing components to fail more frequently and require more frequent maintenance. Additionally, as the rotational speed of the rotating vessel is increased, the failure rate of the drive and bearing components increased.

To relieve the stresses on a cylinder and its bearing and drive components, it has been known to implement a syphon system, which allows the liquid level to be lowered inside the vessel, thereby decreasing the weight carried in the vessel. The known syphon system is either a rotary syphon system or a stationary syphon system. In a rotating syphon system, the syphon turns with the cylinder and is braced inside the cylinder, making for a more rugged syphon construction. In a stationary syphon system, the syphon does not turn with the cylinder and is held in place by the rotary joint. One known syphon system is a slow speed system which typically consists of a rotating joint with a simple bent pipe syphon.

As a vessel's rotational speed is increased and due to centrifugal forces, the media attempts to rotate inside the vessel and causes stresses to be exerted on the slow speed stationary syphon. These stresses, which cause deflection in the syphon pipe and failures of the syphon pipe, are due to the touching of the media and rotating items in the cylinder and may create short circuiting points, breakage of hinged syphon parts, or the snapping off of the syphon pipe where it is held in the rotary joint.

At even faster rotational speeds, high speed stationary syphons are installed because of their lesser differential pressure requirements. Slow speed stationary syphons and high speed stationary syphons differ in the way the syphons are supported. Slow speed stationary syphons have only one point of support, where they are threaded into the rotary joint. A high speed stationary syphon has an intricate cantilever support tube which provides support for the syphon throughout the vessel's journal, i.e., along the syphon's entire horizontal distance.

Slow speed stationary syphons may come in several styles, including, simple bent pipes; substantially straight pipe pieces with a hinged elbow; substantially straight pipe pieces with a hinged elbow and an elbow brace support; substantially straight pipe pieces with a rigid elbow and a flexible dangling hose; and substantially straight pipe pieces with a flexible hose, rigid elbow, and an elbow brace support. While all of these types of syphons have traditionally been supported only from the attachment point inside the rotary joint, additional support mechanisms have been created for the hinged elbow style more recently. However, such support mechanisms are only available for the hinged elbow style syphon, require the use of proprietary straight syphon pipes with modifications for bearing support, and cannot be utilized with any of the other syphon styles. Further, known support mechanisms allow wear on both the inner diameter and outer diameter of a support bearing. Thus, there is a need for an improved support mechanism for use in all slow speed stationary syphon systems.

### SUMMARY OF THE INVENTION

The above-identified problems are solved, and a technical advance is achieved in the art by providing an apparatus and method for supporting a stationary syphon pipe. Providing a secondary support relieves the rotary joint from carrying the entire weight of the syphon or syphon pipe and may provide improved service life for the syphon and rotary joint.

In one embodiment of the present invention, a syphon is supported by a bearing snout having at least one snout stop and a bearing housed in the bearing snout. The bearing rests against the snout stop. The present invention is applicable in all stationary syphon systems, regardless of the syphon pipe type.

Other and further aspects of the present invention will become apparent during the course of the following description.

### BRIEF DESCRIPTION OF THE DRAWINGS

FIG. 1 is a cross-sectional view of a bent pipe syphon system containing an exemplary 20 syphon support flange.

FIG. 2 is an enlarged cross-sectional view of the exemplary support flange in the bent pipe syphon system of FIG. 1.

FIG. 3 is an enlarged cross-sectional view of another exemplary support flange.

FIG. 4 is a cross-sectional view of a hinged elbow pipe syphon system containing the support flange of FIG. 2.

FIG. 5 is a cross-sectional view of a braced hinged elbow pipe syphon system containing the support flange of FIG. 2.

### DETAILED DESCRIPTION OF THE EMBODIMENTS

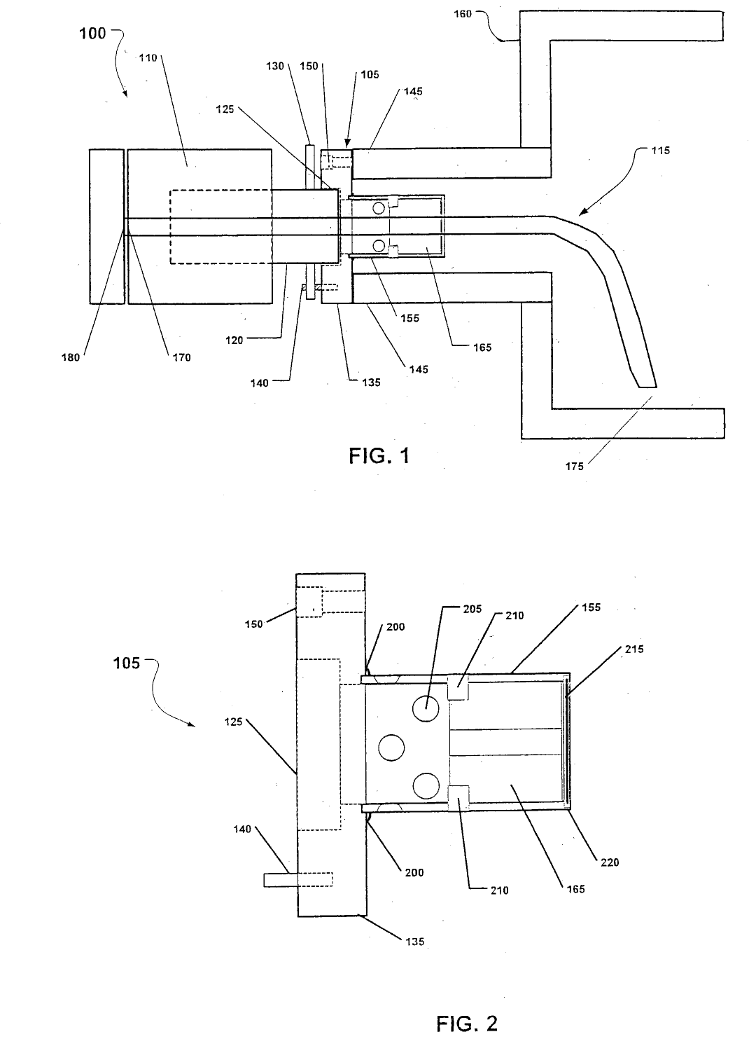

An embodiment of a syphon support mechanism or syphon support flange is illustrated in connection with an exemplary syphon system 100 of FIG. 1. A syphon support flange 105 assists the rotary joint 110 in supporting the syphon or syphon pipe 115. The syphon pipe 115 is usually made of steel or stainless steel. The syphon may be of any type. Some syphon types include bent pipes, hinged elbow pipes, or braced hinged elbow pipes.

Referring now to the drawings wherein like reference numbers refer to like parts, FIG. 1 is a cross-sectional view of a bent pipe syphon system 100 containing a syphon support flange 105. As shown in the bent pipe syphon system 100 of FIG. 1, a shaft 120 is a part of a rotary joint 110. A first or back end of the shaft 120 floats within the rotary joint 110. A second or front end of the shaft 120 is received by a first or back end of a shaft connection 125. A second end of the shaft connection 125 is preferably a quick release style or any style which may be securely fastened in the journal flange, such as with the use of a slip flange 130 and the shaft 120 passes through the slip flange 130. In a quick release style connection, the shaft connection is held in place by a slip-ring or nipple flange. The shaft 120 may be made of steel, ductile iron, brass, or stainless steel. In an alternative embodiment, the second end of the shaft connection may be threaded or machined to mate with a threaded connection on the shaft.

The slip flange 130 is attached to a first or front side of a journal flange 135. The slip flange 130 is preferably made of steel, but it may be made of any other machinable, hard, strong material, such as brass, cast iron, or ductile iron. The slip flange 130 may be attached to the front side of the journal flange 135 using any number of fastening or first attachment means, such as by screws or other fasteners 140.

The front side of the journal flange 135 is machined to fit the shaft connection 125. A second or back side of the journal flange 135 is machined, preferably on the centerline, to accept a bearing snout 5. The back side of the journal flange 135 attaches to a cylinder journal 145 by a known second attachment means, such as bolts 150.

The journal flange 135 is preferably made of steel, but it may be made of any other machinable, hard, strong material, such as brass, cast iron, or ductile iron. The journal flange 135 may be flat faced, female counterbored, or male piloted to help secure the journal flange 135 to the journal end of a vessel on center. To obtain a snug fit between the cylinder journal 145 and the journal flange 135, the journal flange 135 is preferably machined.

The backside of the journal flange 135 contains a recessed cavity which mates with a first or back end a bearing snout 155. The bearing snout 155 is preferably manufactured from steel or stainless steel. As shown in the embodiment of FIG. 2, the journal flange 135 may be secured to the back end of the bearing snout 155 by any number of attachment means such as by welds 200.

Referring to FIG. 1, while the journal flange 135 is preferably attached to the bearing snout 155 with welds 200, the journal flange 135 may be manufactured in an alternative fashion to attach to the back end of the bearing snout 155 without welds, such as by bolting or tightly securing or squeezing the bearing snout between the journal flange 135 and an end of the cylinder journal 145 of a cylinder or dryer or cooling roll or vessel 160. In such an embodiment, the bearing snout 155 is an additional component to known syphon systems, and such systems would require no modification.

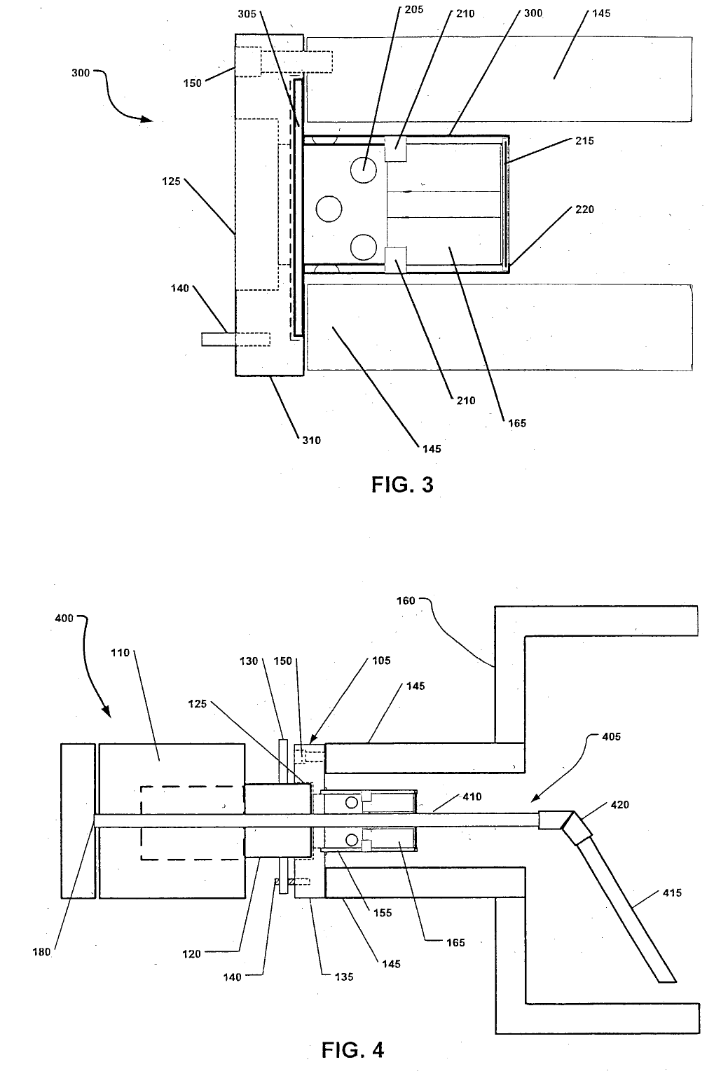

Referring to FIG. 3, the bearing snout 300 is mounted or attached to a plate or lip 305 which rests against a shoulder of the journal flange 310. To prevent the bearing snout 300 from sliding into the cylinder journal 145 of cylinder 160, the lip 305 may be secured into place by sandwiching the lip 305 of the bearing snout 300 in place between the journal flange 310 and cylinder journal 145 of cylinder 160.

Referring to FIG. 1, the syphon 110 extends from the rotary joint 115 and passes through the shaft 120, the slip flange 130, the shaft connection 125, the syphon support flange 105, the bearing snout 155, a secondary syphon support or bearing 165 housed in the bearing snout 155 and the cylinder journal 145 and extends downward into the cylinder 160.

FIG. 2 is an enlarged cross-sectional view of the syphon support flange 105. The bearing snout 155 contains at least one media flow hole or aperture 205 through which media passes. The media flows through the rotary joint 115, through the shaft 120, and out of the media flow hole 205. The media may be steam, hot oil, water, or glycol. Preferably, the number of media flow holes 205 have a flow area greater than or equal to the flow area of a syphon system without a bearing snout 155. The media hole 205 is preferably machined into the bearing snout area closest to the backside of journal flange 135 and in front of a snout stop or bearing stop 210, as seen in FIG. 2.

The bearing snout 155 has at least one bearing stop 210. The bearing stop 210 may be attached to the bearing snout 155 using any number of attachment means, such as one or more bolts, welds, and screws, or keying. The bearing stop 210 may also be formed on the inner wall of the bearing stout 155, such as by machining. The length between the bearing stop 210 and a second or front side of the bearing snout 155 is sufficient to house the bearing 165. One or a first end of a bearing 165 may be keyed to mate with the bearing stop 210.

The bearing 165 is preferably a driven bearing and held substantially stationary within the bearing snout 155 in order to minimize wear on the bearing snout 155. The bearing 165 may be held substantially stationary by any number of holding means, such as by designing the bearing 165 to snugly or tightly fit against the inner wall of the bearing snout 155.

Alternatively, the bearing may have at least one notch or cutout which interconnects or mates with at least one protrusion on the inner wall of the bearing snout 155. The bearing rest against the bearing stop 210.

The bearing 165 has an inside diameter of sufficient width through which the syphon 115 may pass. The bearing 165 preferably snugly or tightly fits around the syphon 115. The bearing 165 is preferably manufactured of a sacrificial bearing material capable of withstanding high temperatures and wear, such as carbon graphite or other material in the form of TFE-fluorocarbon and other inert ingredients. One such material is known as Rulon® and is marketed by Dixon Industries Corporation.

The bearing 165 is secured and prevented from falling out of the bearing snout 155 by a securing means. The securing means may be any number of components, such as stops on the front side of the bearing snout, bolts, or welds. Preferably, an internal snap ring 215 secures the bearing 165 in place, such as by fitting into a recessed cavity or snap ring groove 220 on the inside of the wall of another or second end of the bearing snout 155. The snap ring 215 is preferably made of steel or stainless steel but may be made of other rigid material.

In one alternative embodiment of the syphon support flange 105, the syphon support flange has the same features as the syphon support flange 105 in FIG. 2 but is one continuous machined piece.

In yet another embodiment of a syphon support flange, the bearing is mounted or attached directly to the journal flange 135. The mounting means or attachment means may be any number of securing methods, such as glue or bolts.

The syphon support flange 105 may be manufactured as follows. Media flow holes 205 are machined into the bearing snout 155, and the bearing stops 210 are welded to or formed on the inside wall of the bearing snout 155 prior to mounting the bearing snout 155 to the journal flange 135. The journal flange 135 is secured to the bearing snout 155 by welds 200. The inside diameter of the bearing snout 155 is then machined to attain concentricity on the inside diameter, i.e., machined to correct the true center of the inside diameter. The internal snap ring groove 220 may be machined on the inner wall of the bearing snout 155. It should be noted that the steps enumerated above may be performed in any order and not necessarily in the order described.

The bearing 165 is then inserted into the bearing snout 155 through the backside of the bearing snout 155 until it rests against the bearing stop 210 and passes the snap ring groove 220. An internal snap ring 215 is then preferably inserted into the snap ring groove 220 to secure the bearing 165 in place.

Referring to FIG. 1, to install the syphon support flange 105 in the bent pipe syphon system 100, the rotary assembly, which consists of the rotary joint 110, syphon 115, and journal flange 135, is detached from the cylinder journal 145. The syphon 115 is then detached from the rotary joint 110. The bearing snout 155 is attached to the journal flange 135, and the bearing 165 is inserted into the bearing snout 155. The bearing 165 is then secured against the bearing stop 210 by the securing means. Alternatively, the bearing may be inserted and secured in the bearing snout 155 prior to attaching the bearing snout 155 to the journal flange 135.

One or a first end 170 of the syphon 115 passes through the shaft 120, the slip flange 130, the shaft connection 125, the syphon support flange 105, the bearing snout 155, the bearing 165 housed in the bearing snout 155 and the cylinder journal 145, preferably in an inside to outside fashion. The syphon support flange 105 and syphon 115 are inserted into the cylinder journal 145, and another or second end 175 of the syphon 115 extends downward into the cylinder 160.

The syphon support flange 105 is attached to the cylinder journal 145 by the second attachment means 150 that extends through a cavity in the syphon support flange 105. The second attachment means 150 may be any type of fastener, such as socket head cap screws or hex head bolts, and is preferably made of steel. The first end 170 of the syphon 115 is then secured to the syphon connection 180 inside the rotary joint 110. Securing the first end 170 of the syphon 115 may be accomplished by any number of known methods such as with bolts. The first end 170 of the syphon 115 may also be threaded to mate with threads in the rotary joint 110.

The rotary joint 110 may then be secured to the syphon support flange 105 by inserting the shaft 120 into a recess in the shaft connection 125 and by a slip flange 130 attached by a first attachment means 140. The first attachment means 140 may be any type of fastener, such as socket head cap screws or hex head bolts, and is preferably made of steel. Alternatively, the shaft 120 may be threaded and secure to the journal flange with mating threads. It should be noted that the steps enumerated above to assemble the syphon support system may be performed in any order and not necessarily in the order described.

FIG. 4 is a cross-sectional view of a hinged elbow pipe syphon system 400 containing the syphon support flange 105. To install the syphon support flange 105 in the hinged elbow pipe syphon system 400, the rotary joint 110, syphon 405, and journal flange 135 are removed from the cylinder journal 145. The bearing snout 155 is attached to the journal flange 135, and the bearing 165 is inserted into the bearing snout 155. The bearing 165 is then secured against the bearing stop 200 and prevented from falling out of the bearing snout 155 by a securing means. The securing means may be any number of components, such as at least one stop on the front side of the bearing snout, bolts, or welds. Preferably, an internal snap ring secures the bearing 165 in place, such as by fitting into a recessed cavity or snap ring groove on the inside wall of the second end of the bearing snout 155. The snap ring is preferably made of steel or stainless steel but may be made of other rigid material. Alternatively, the bearing may be inserted and secured in the bearing snout 155 prior to attaching the bearing snout 155 to the journal flange 135.

The syphon 405 has a first or substantially straight or horizontal portion 410 and a second portion 415. The first and second portions 410, 415 each connect to an elbow hinge 420 at a first end. The elbow hinge 420 may be made of a sturdy material, such as ductile iron, cast iron, brass, steel, or stainless steel. The second portion 415 dangles or hangs down into the cylinder 160.

The first portion 410 of the syphon 405 is inserted through the bearing 165 of the syphon support flange 105, preferably in an inside to outside fashion. The syphon support flange 105 and syphon 405 are inserted into the cylinder journal 145. The syphon support flange 105 is attached to the cylinder journal 145 by the second attachment means 150 that passes through the syphon support flange 105. The second attachment means 150 may be any type of fastener, such as socket head cap screws or hex head bolts, and is preferably made of steel. A second end of the first portion 410 of the syphon 405 is secured to the syphon connection 180 inside the rotary joint 110. The rotary joint 110 may then be secured to the syphon support flange 105 by inserting the shaft 120 into shaft connection recess 125 and by a slip flange 130 attached by a first attachment means 140. The second attachment means 150 may be any type of fastener, such as socket head cap screws or hex head bolts, and is preferably made of steel.

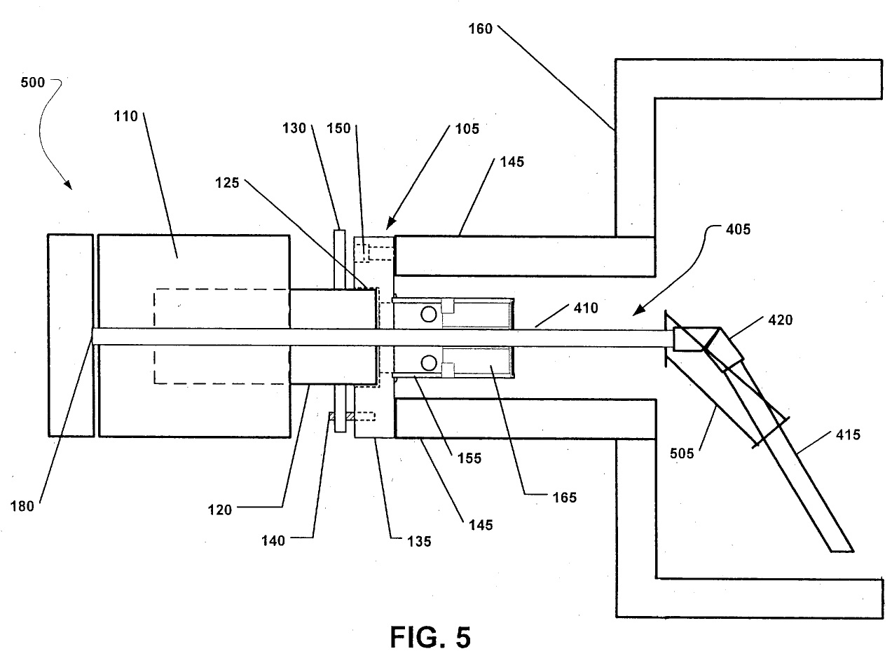

FIG. 5 is a cross-sectional view of a braced hinged elbow pipe syphon system 500 containing the support flange 105. To install the syphon support flange 105 in the braced hinged elbow pipe syphon system 500, the rotary joint 110, syphon 405, and journal flange 135 are removed from the cylinder journal 160. The bearing snout 155 is attached to the journal flange 135, and the bearing 165 is inserted into the bearing snout 155. The bearing 165 is then secured against the bearing stop 200 prevented from falling out of the bearing snout 155 by the securing means. The securing means may be any number of components, such as at least one stop on the front side of the bearing snout, bolts, or welds. Preferably, an internal snap ring secures the bearing 165 in place, such as by fitting into a recessed cavity or snap ring groove on the inside wall of the second end of the bearing snout 155. The snap ring is preferably made of steel or stainless steel but may be made of other rigid material. Alternatively, the bearing may be inserted and secured in the bearing snout 155 prior to attaching the bearing snout 155 to the journal flange 135.

The syphon 405 has a first or substantially straight or horizontal portion 410 and a second portion 415. The first and second straight portions 410, 415 each connect to an elbow hinge 420. The elbow hinge 420 may be made of sturdy material, such as ductile iron, cast iron, brass, steel, or stainless steel. The second portion 415 dangles or hangs down into the cylinder.

The syphon 405 also has a brace 505. One end of the brace 505 is attached to the first straight portion 410 of the syphon 405, and a second end of the brace 505 is attached to the second straight portion 415 of the syphon 405. The brace 505 provides additional support for the elbow hinge 420.

The first portion 410 of the syphon 405 is inserted through the bearing 165 of the syphon support flange 105, preferably in an inside to outside fashion. The syphon support flange 105 and syphon 405 are inserted into the cylinder journal 145. The syphon support flange 105 is attached to the cylinder journal 145 by the second attachment means 150 that passes through the syphon support flange 105. The second attachment means 150 may be any type of fastener, such as socket head cap screws or hex head bolts, and is preferably made of steel. A second end of the first portion 410 of the syphon 405 is secured to the syphon connection 180 inside the rotary joint 110. The rotary joint 110 may then be secured to the syphon support flange 105 by inserting the shaft 120 into shaft connection recess 125 and by a slip flange 130 attached by a first attachment means 140. The first attachment means 140 may be any type of fastener, such as socket head cap screws or hex head bolts, and is preferably made of steel.

The many features and advantages of the present invention are apparent from the detailed specification, and thus, it is intended by the appended claims to cover all such features and advantages of the invention which fall within the true spirit and scope of the invention.

1. An apparatus for supporting a syphon comprising:
a bearing snout having at least one stop; and
a bearing housed in the bearing snout, the bearing resting against the bearing stop.

2. The apparatus according to claim 1, wherein the bearing stop is formed on the bearing snout.

3. The apparatus according to claim 1, wherein the bearing stop is attached to the bearing snout.

4. The apparatus according to claim 3, wherein the bearing stop is attached to the bearing snout with at least one weld.

5. The apparatus according to claim 1, wherein the bearing is keyed to interconnect with the bearing stop.

6. The apparatus according to claim 1, further comprising a snap ring, the snap ring securing the bearing in the bearing snout.

7. The apparatus according to claim 1, wherein the bearing snout has a lip which rests against a shoulder of a journal flange.

8. The apparatus according to claim 1, further comprising a journal flange attached to the bearing snout.

9. The apparatus according to claim 8, wherein the bearing snout is attached to the journal flange with welds.

10. The apparatus according to claim 1, wherein the bearing snout has a threaded connection, the threaded connection mating with a threaded connection in the journal flange.

11. An apparatus for supporting a syphon comprising:
a journal flange, and
a bearing attached to the journal flange.

12. An apparatus for supporting a syphon comprising:
a flange with a bearing snout mounted to a cylinder; and
a bearing housed in the bearing snout, wherein the bearing snout has at least one stop.

13. A syphon support system comprising:
a journal flange attached to a cylinder;
a bearing snout attached to the journal flange having at least one stop;
a bearing housed in the bearing snout, the bearing resting against the stop; and
a syphon attached to a rotary joint, wherein the syphon passes through the bearing and extends into the cylinder.

14. The syphon support system according to claim 13, wherein the syphon is a bent pipe.

15. The syphon support system according to claim 13, wherein the syphon is a hinged elbow.

16. The syphon support system according to claim 13, wherein the syphon is a braced hinged elbow.

17. A method of assembling a syphon support system comprising:
inserting a bearing inside a first end of a bearing snout having at least one stop, a first end of the bearing resting against the stop; and
securing a second end of the bearing snout to a journal flange.

18. The method according to claim 17, further comprising inserting a snap ring against a second end of the bearing.

19. A syphon support system comprising:
a journal flange attached to a cylinder;
a bearing attached to the journal flange; and
a syphon attached to a rotary joint, wherein the syphon passes through the bearing and extends into the cylinder.
